(19) United States
(12) Patent Application Publication
(10) Pub. No.: US 2019/0220940 A1
(43) Pub. Date: Jul. 18, 2019

(54) SYSTEMS AND METHODS FOR VISUAL SCHEDULE BUILDING

(71) Applicants: Alan Weeks, Vaudreuil-Dorion (CA); Sean Weeks, Vaudreuil-Dorion (CA)

(72) Inventors: Alan Weeks, Vaudreuil-Dorion (CA); Sean Weeks, Vaudreuil-Dorion (CA)

(21) Appl. No.: 16/364,164

(22) Filed: Mar. 25, 2019

Related U.S. Application Data
(63) Continuation-in-part of application No. 13/887,332, filed on May 5, 2013, now abandoned.

(51) Int. Cl. G06Q 50/20; G06Q 10/10; G06F 16/2457

(52) U.S. Cl. CPC G06Q 50/2053; G06F 16/24575; G06Q 10/1093

(57) ABSTRACT

Methods, systems and computer readable media for visual schedule building are disclosed.

### CROSS REFERENCE TO RELATED APPLICATIONS

This application is a continuation-in-part of application Ser. No. 13/887,332, filed on May 5, 2013.

### TECHNICAL FIELD

Embodiments relate generally to computerized scheduling systems, and more particularly, to methods, systems and computer readable media for visual schedule building.

### BACKGROUND

Some existing computerized scheduling systems may not provide a convenient way to visualize a schedule. Moreover, some existing scheduling systems may not provide a graphical user interface for visually building a schedule including desired resource days/times and days/times when no resources should be scheduled. For example, traditional computerized scheduling systems typically allow students to register for a selected course but may not help students preview schedules comprising the selected courses prior to enrolling in those selected courses. Also, traditional computerized scheduling systems may not enable students to add or delete courses to previewed schedules prior to enrollment, nor may they enable comparison.

Embodiments were conceived in light of the above mentioned needs, problems and/or limitations, among other things.

### SUMMARY

One or more embodiments can include a method for visual schedule building. The method can include connecting, using one or more processors, to a resource database. The method can also include receiving, at the one or more processors, static resource data from the resource database and receiving, at the one or more processors, dynamic resource data from the resource database.

The method can further include obtaining, at the one or more processors, user resource selections. Obtaining user resource selections can includes obtaining one or more active institution/organization time durations (e.g., school terms), presenting, for display to the user, courses associated with the one or more active terms, and obtaining an add indication from the user for one or more courses.

The method can also include generating, using the one or more processors, a set of results based on the user resource selections, the set of results including one or more weekly schedules. The method can further include providing user interface controls adapted to permit the user to visually move through the set of results by displaying a weekly view of one weekly schedule from the set of results.

The method can also include providing a user interface element adapted to permit the user to graphically select time blocks to avoid scheduling courses in and resorting the results set based on selected time blocks to avoid. The method can further include obtaining one or more limiting selections and generating a new set of results based on the limiting selections.

Obtaining the user resource selections can further include receiving one or more section preferences. Obtaining the user resource selections can further include receiving a sort preference.

The user interface can include a combined user interface with a first section adapted to permit a user to search courses, a second section adapted to add courses and a third section adapted visually review the results in an integrated interface.

Some implementations can include a system comprising one or more processors configured to perform operations. The operations can include the method steps described above. Further, the system can include other features as mentioned above regarding the method implementation.

Some implementations can include a nontransitory computer readable medium having stored thereon software instructions that, when executed by a processor, cause the processor to perform operations. The operations can include the method steps described above. Further, the system can include other features as mentioned above regarding the method implementation.

### BRIEF DESCRIPTION OF THE DRAWINGS

FIG. 1 is a diagram of an example visual schedule building environment for course schedules in accordance with at least one implementation.

FIG. 2 is a diagram of an example visual schedule building environment for resource scheduling in accordance with at least one implementation.

FIG. 3 is a flow chart showing an example method for visual schedule building in accordance with at least one implementation.

FIG. 4 is a flow chart showing an example method for visual schedule building in accordance with at least one implementation.

FIG. 5 is a diagram of an example computer system for visual schedule building in accordance with at least one implementation.

FIG. 6 is an example user interface for visual schedule building in accordance with at least one implementation.

FIG. 7 is an example integrated user interface for visual schedule building in accordance with at least one implementation.

### DETAILED DESCRIPTION

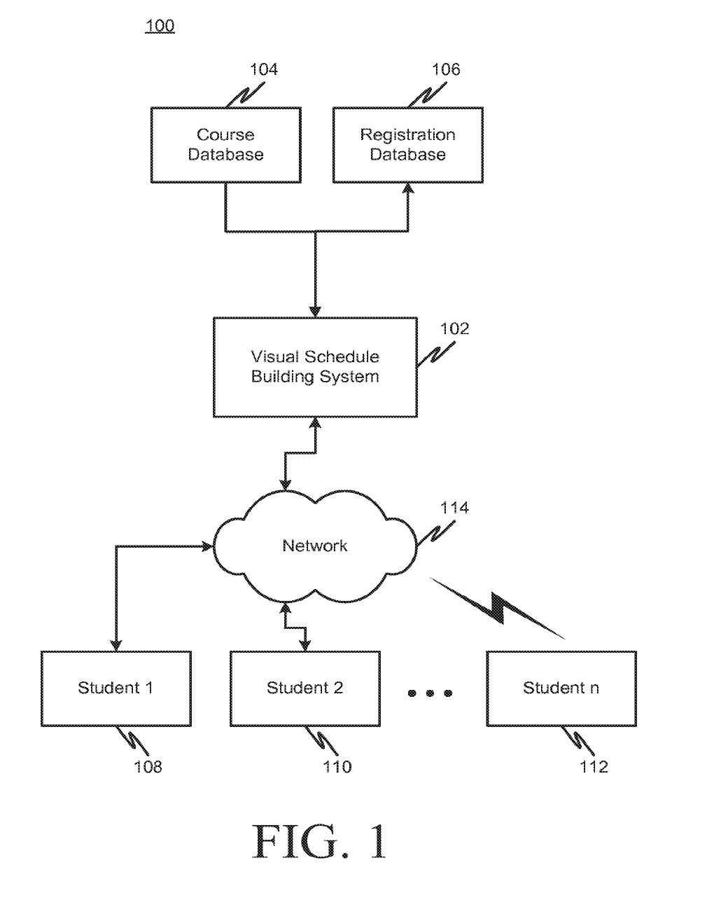

FIG. 1 is a diagram of an example visual schedule building environment 100 for course schedules in accordance with at least one implementation. The environment 100 includes a visual schedule building system 102 adapted for use in scheduling courses, such as university or college courses, or courses (or other types of presentations) for other types of institutions or organizations. The visual schedule building system 102 is coupled to a course database 104 and a registration database 106. The visual schedule building system 102 may be coupled to the databases (104 and 106) via one or more intermediate systems.

A plurality of students (108-112) can access the visual schedule building system 102 via a wired and/or wireless network 114.

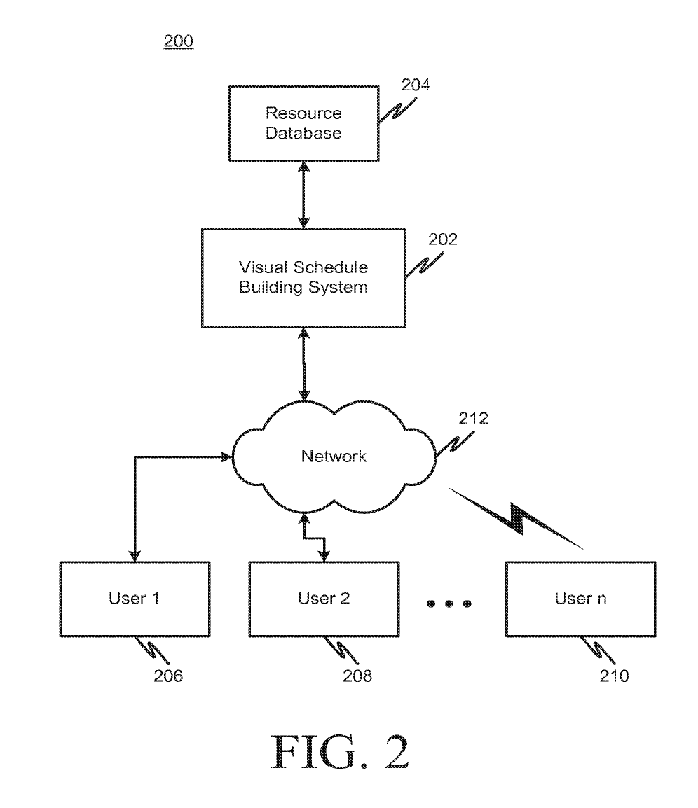

While course scheduling embodiments are described herein, it will be appreciated that the visual schedule building system disclosed herein can be adapted for use in scheduling other types of resources. For example, FIG. 2 is a diagram of an example visual schedule building environment 200 for resource scheduling. The environment 200 includes a visual schedule building system 202 adapted for use in scheduling resources, such as personnel, physical spaces, equipment or other resources where scheduling may be appropriate or desirable. The resources can be scheduled for one or more time durations (e.g., a time period with a start date and time and an end date and time). The visual schedule building system 202 is coupled to a resource database 204. The visual schedule building system 202 may be coupled to the databases 204 via one or more intermediate systems.

A plurality of users (206-210) can access the visual schedule building system 102 via a wired and/or wireless network 212.

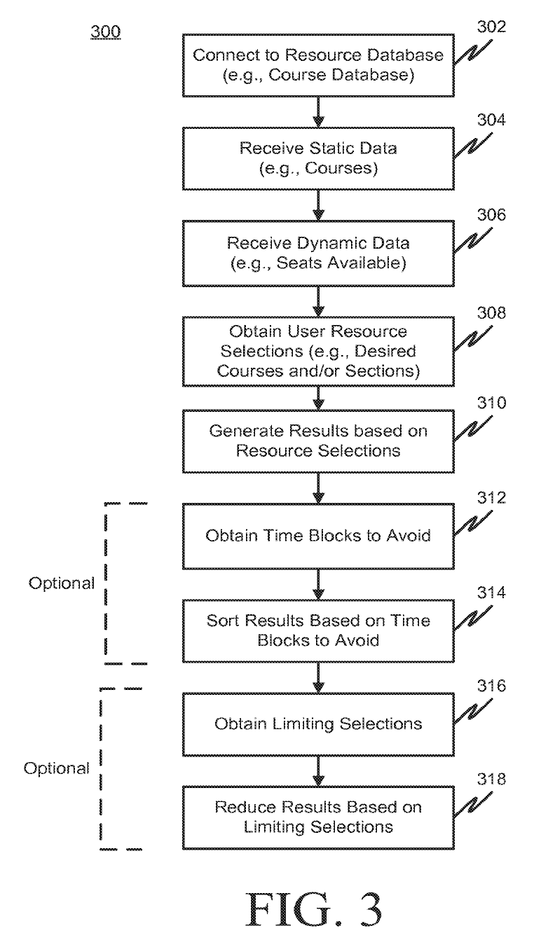

FIG. 3 is a flow chart showing an example method 300 for visual schedule building. Processing begins at 302, where a system (e.g., 102 or 202) connects to a resource database (e.g., 104/106 or 204). Processing continues to 304.

At 304, static resource data is received. Static data can include courses available or one or more active terms. Processing continues to 306.

At 306, dynamic data is received. The dynamic data can include data related to or associated with the static data. For example, a number of seats available for each course can be received. Receiving dynamic resource data can be repeated periodically (e.g., every 5 minutes) as appropriate for a contemplated application. Processing continues to 308.

At 308, one or more user resource selections are obtained. Obtaining the user resource selections can include obtaining one or more active institution/organization time durations (e.g., school terms), presenting, for display to the user, courses and sections associated with the one or more active time durations, and obtaining an add indication from the user for selecting the one or more courses and/or sections available within the time durations, prior to enrolment, to simulate a class schedule. Processing continues to 310.

At 310, results are generated based on the user resource selections. For example, the system can retrieve a results set including all combinations of the desired (selected) courses and/or sections. Processing continues to 312.

At 312, one or more time blocks to avoid (e.g., time constraints) are optionally obtained. The time blocks to avoid can be obtained via a user interface (e.g., 600 or 700, described below) that is adapted to permit a user to graphically select time blocks (hours and/or days) from a visual schedule interface to block. The user can select the same time block for each day of the week or different time blocks for different days of the week. The user can select to repeat the time blocks selected for a week for one or more other weeks in the active time duration or choose different combinations of time blocks for different weeks in the one or more above active time durations. The time blocks to avoid can be selected via a “click and drag” technique or other means on the visual schedule table view graphical user interface. Processing continues to 314.

At 314, if time blocks to avoid have been selected, the results can be resorted based on the time blocks to avoid in order to present the course schedules that most closely match the user's desired courses and time blocks to avoid. Processing continues to 316.

At 316, one or more limiting selections are optionally obtained. In a course scheduling implementation, limiting selections can include but are not limited to hiding one or more specific courses based on pre-determined criteria such as the class capacity, hiding full sections, hiding online classes, hiding honors classes, and/or hiding waitlisted classes. Processing continues to 318.

At 318, when limiting selections have been received, the results can be reduced (e.g., pruned) based on the limiting selections. For example, if hide full sections is selected, the results can be pruned to eliminate any schedule combination that include one or more full sections. If hide online classes is selected, the results are filtered to remove any schedule combination that includes one or more online classes. Similarly, if hide honors classes is selected, the results are reduced to omit any schedule combination that includes one or more honors classes in schedule.

It will be appreciated that 302-318 can be repeated in whole or in part in order to accomplish a contemplated visual schedule building task. Further, 302-318 are not limited to being performed in the order shown and may be performed in a different order. The disclosure therefore enables automatic generation of multiple schedule options based on predetermined and/or user selected criteria in a graphical user interface. The disclosure also automatically displays the generated schedule options on a graphical user interface in real-time in some implementations. The automatic display of schedule options need not always be in real-time.

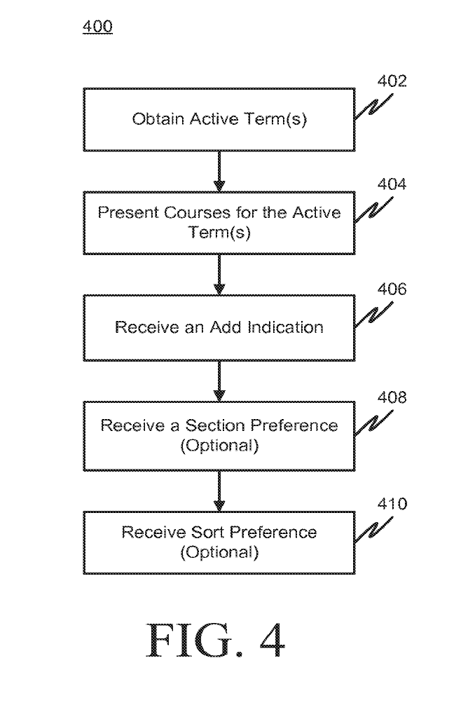

FIG. 4 is a flow chart showing an example method 400 for visual schedule building. In particular, 400 shows step 308 from FIG. 3 in greater detail. Processing begins at 402, where one or more active school terms are obtained (these can be obtained from a user or from a course and/or registration database). Processing continues to 404.

At 404, the courses available for the active term(s) are presented. For example the course can be shown on a user interface (e.g., 600 or 700) in response to a user search query or other user input. Processing continues to 406.

At 406, an indication to add one or more courses is obtained. Processing continues to 408.

At 408, a course section preference is optionally received. Processing continues to 410.

At 410, a sort preference is optionally received. The sort preference can be used as a criterion by which to rank and order the result set of course schedules. The sort preference can include but is not limited to most days off, morning classes, mid-day classes, evening classes, time off campus, healthy schedule (e.g., balanced day with time for lunch), a customized sort preference choice and/or a highest score sort preference. For example, the healthy schedule sort preference ranks schedules that do not have any classes during lunch time during the week, that are not packed with back to back classes, that do not have snack breaks or bio-breaks between classes or sets of classes, and/or that do not have more than a set number of classes in a day.

The courses added, section preference and sort preference can all be used to retrieve and sort a result set of course schedules. Further, it will be appreciated that a portion of the steps of FIGS. 3 and/or 4 can be performed on a server side and a portion can be performed on a local device (e.g., desktop, laptop, tablet, wireless phone or the like). Alternatively, the steps can be performed all on the server side or all on the client device side.

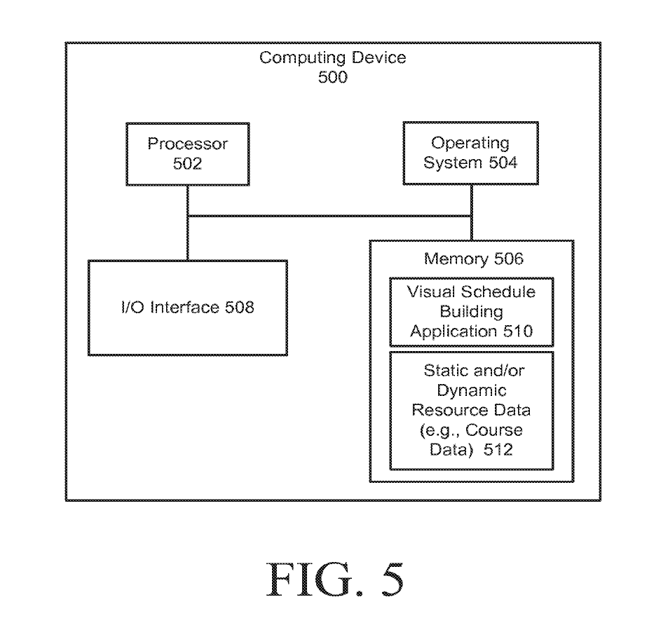

FIG. 5 is a diagram of an example computer 500 in accordance with at least one embodiment. The computer 500 includes a processor 502, operating system 504, memory 506 and I/O interface 508. The memory 506 can include a visual schedule building application 510 and a database 512 (e.g., for storing static and/or dynamic course data or data associated with other scheduled resources).

In operation, the processor 502 may execute the application 510 stored in the memory 606. The application 510 can include software instructions that, when executed by the processor, cause the processor to perform operations for network management in accordance with the present disclosure (e.g., performing one or more of steps 302-318 and/or 402-410 described above).

The application program 510 can operate in conjunction with the database 512 and the operating system 504. The computer 500 can illustrate an example server, user device or both.

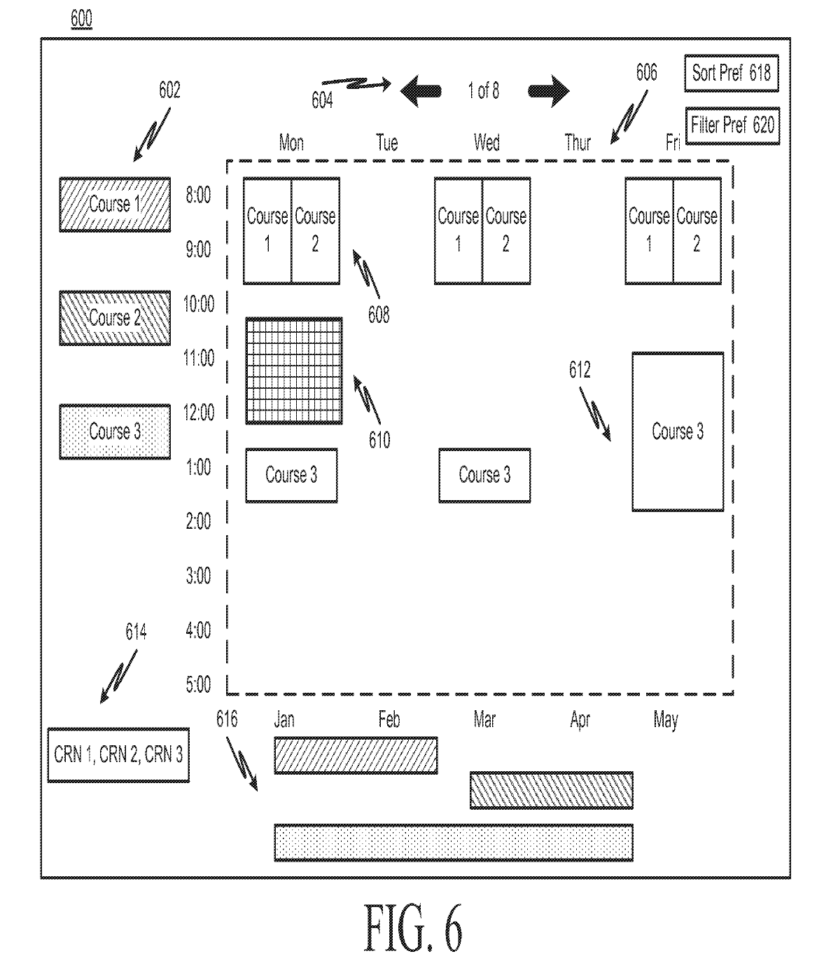

FIG. 6 is an example graphical user interface 600 for visual schedule building. The interface 600 includes a list of selected (or added) courses 602 and elements 604 for navigating among result schedules (the result schedules can be rotated though the framework of the fixed schedule table view 606). Other means of navigation are possible as well. The graphical user interface can optionally allow users to see minimized views of multiple result schedule options together at the same time and/or compare one or more of result schedule options side by side.

The fixed table view 606 shows selected courses 608 (as shown course 1 and course 2 occupy the same time slot, but do not occur during the same calendar days, see 616). The fixed table view 606 also shows a time block to avoid 610 and a course with variable time length on different days 612 of the same week (e.g., a one-hour lecture with a two-hour lab component).

The interface 600 includes elements for selecting sort preference 618, filter preference 620 (or limiting preferences) and auto-populated course reference numbers for use in cut and pasting into another system (e.g., the registration system). In other words, the visual schedule builder can operate as a stand-alone program to be used for building schedules or as a program integrated with the registration system. Such options are not available in traditional schedule building interfaces, which typically allow users to select a schedule and modify that schedule. The present disclosure also enables users to simulate course schedules by building variations of course schedules through one or more simulations prior to enrollment. After reviewing the course schedules from the one or more simulations, a user can select the desired schedule and register the confirmed course schedule for enrollment during the corresponding active time duration. Traditional schedule building interfaces typically allow building of one schedule at a time.

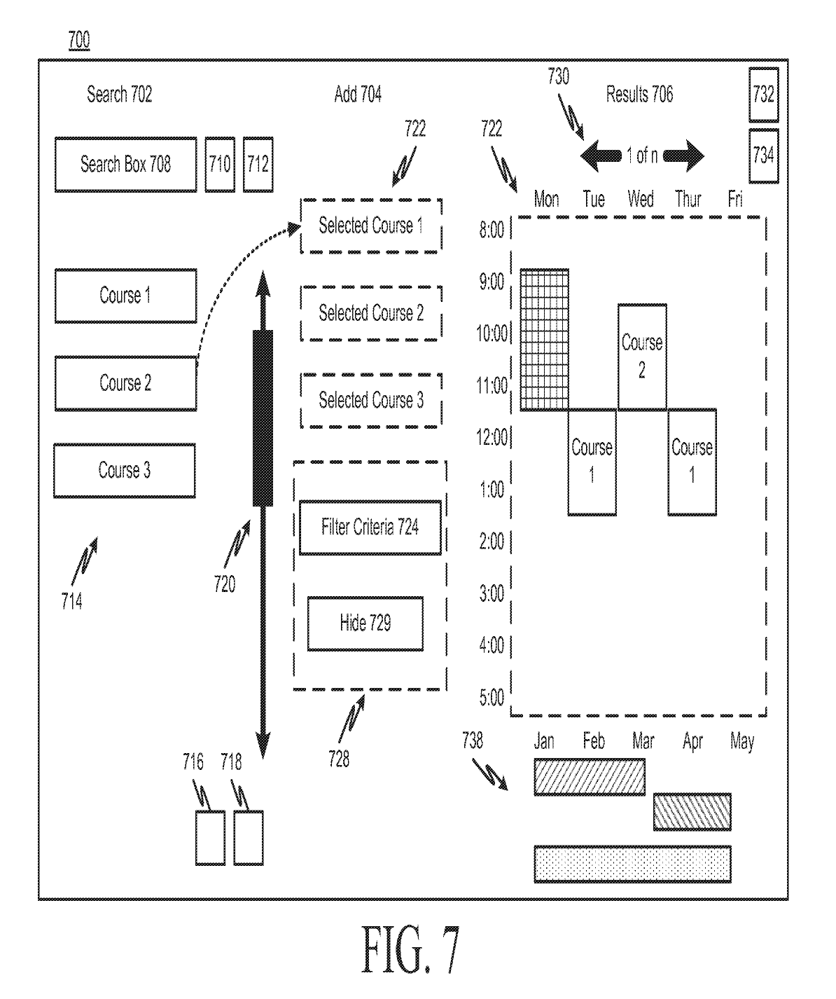

FIG. 7 is an example integrated user interface 700 for visual schedule building. The interface 700 includes a search section 702, an add section 704, and a schedule fixed table result view section 706. Other implementations may include variations of the result view section 706. Minimized views of multiple result schedule options can optionally be displayed simultaneously in the view section 706 and/or a comparison of one or more of the result schedule options side by side can be displayed in the view section 706 also. In some implementations, the search section 702 and/or the add section 706 can be minimized to make more space for the result view section. The search section 702 and the add section 706 can be organized in different ways, including placing one section above the other to make more space for the result view section 706.

The search section 702 includes a search box 708 (used for entering search terms such as course name, section name, instructor and the like), a catalog selection element 710 for searching the entire course catalog or specific catalogs, and a start search element 712.

The list of result courses 714 from the search can be shown. The interface 700 also includes elements for selecting icon view 716 or list view 718. The list of search results can be scrolled using element 720.

A course in the search results 714 can be added to the course list 722 via “drag and drop” as shown by the dashed arrow. The results set can be limited (or filtered) using the filter criteria 724 and/or the hide criteria 729. The hide or filter criteria can include full courses, honors courses, online courses, specific courses based on pre-determined criteria, waitlisted courses, campus preference (for multi-campus institutions), distance between courses based on time between courses (e.g., a student may not want to have only a few minutes to walk across campus, more time may be needed or preferred), specified number of seats available in a class, and the like. The distance between where the courses are being taught is used to determine the time needed to travel from one course location to the next course location and a course that does not have enough time for a student to walk from the previous course location to the said course can be hidden and/or filtered out as a student will not be able to reach the said course in time from the previous course. For each course added to the course schedule by a user, the time and/or distance information corresponding to the time and/or distance with respect to the course preceding the added course can be displayed to help the user make an informed choice. The hide/filter section 728 of the add section 706 can be minimized in some implementations.

The course combinations shown in the fixed weekly schedule table view 722 can be changed through the result set using the controls 730. Other display options are possible also. Minimized views of multiple result schedule options can optionally be displayed simultaneously in the weekly schedule view 722 and/or comparison of one or more of the result schedule options side by side can be displayed as well. An element 732 for sharing (e.g., via email, link, calendar, social network post or the like) and exporting 734 can be provided in the interface 700. Controls 730 can take different forms (e.g., a vertical scroller) in some other implementations.

The calendar month view 738 can include start and stop markers (not shown) that can be positioned to filter by course start/end date, respectively.

Also, in some implementations, when a mouse or pointer hovers over a section listing, a faint “ghost” of that section can be displayed on the fixed table view.

The course information can be downloaded to the visual scheduling system so that the search and sort can be done locally, which may improve response time. The course information includes active courses, where the active courses are courses with one or more seats available for students to enroll in. Active courses are identified with an identifier in some implementations to enable users to differentiate between classes that are full and classes that are active (i.e., not full).

Also, a selected schedule can be sent to a registration system for enrolment when the student/user has completed the visual schedule building and has selected a schedule from the different schedule options provided by the visual scheduling building system for course registration.

The modules, processes, systems, and sections described above can be implemented completely or for the most part on a user device instead of on a server to reduce the computing load on the server, to conserve server resources and to more efficiently utilize server resources.

The modules, processes, systems, and sections described above can be implemented completely or for the most part on a user device instead of on a server to allow users to avoid sharing simulated schedules with the visual scheduling building system and to maintain privacy until the final schedule is submitted. It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for visual schedule building.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
connecting, using one or more processors, to a resource database;
receiving, at the one or more processors, static resource data from the resource database;
receiving, at the one or more processors, dynamic resource data from the resource database, wherein the dynamic resource data includes active course data and number of seats available in each active course, wherein the active course includes one or more available seats, and wherein the dynamic resource data is generated and received in real-time, and wherein the receiving of the dynamic resource data is repeated periodically to obtain up to date information;
obtaining, at the one or more processors, user resource selections, wherein obtaining user resource selections includes:
obtaining one or more active school terms;
presenting, for display to a user, the active courses associated with the one or more active school terms; and
obtaining an add indication from the user for the one or more active courses, wherein the add indication corresponds to simulation of a course schedule prior to enrolment;
generating, using the one or more processors, a set of results based on the static resource data, the dynamic resource data and the user resource selections, the set of results including one or more weekly schedules; and
providing user interface controls adapted to permit the user to visually move through the set of results by displaying a weekly view of one weekly schedule from the set of results.

2. The method of claim 1, further comprising:
providing a user interface element adapted to permit the user to graphically select time blocks to avoid scheduling courses in; and
re-sorting the results set based on selected time blocks to avoid.

3. The method of claim 1, further comprising:
obtaining one or more limiting selections, wherein the one or more limiting selections include full courses, honors courses, online courses, waitlisted courses, full sections, class capacity, number of seats available, campus preferences, and one or more of time or distance between two courses that are adjacent in a schedule; and
generating a new set of results based on the limiting selections.

4. The method of claim 1, wherein obtaining the user resource selections further includes receiving one or more section preferences.

5. The method of claim 1, wherein obtaining the user resource selections further includes receiving a sort preference, wherein the sort preference includes most days off, morning classes, mid-day classes, evening classes, time off campus, healthy schedule with a lunch break, weekly schedule with balanced workload distributed over a week, and a highest score sort preference.

6. The method of claim 1, wherein the user interface includes a combined user interface with a first section adapted to permit a user to search courses, a second section adapted to add courses and a third section adapted visually review the results in an integrated interface.

7. The method of claim 1, wherein receiving an indication from the user on one of the results causes displaying within the weekly view a limited view of a selected course corresponding to the result.

8. The method of claim 1, wherein the method is performed entirely on a user device.

9. A system comprising one or more processors configured to perform operations including:
connecting, using one or more processors, to a resource database;
receiving, at the one or more processors, static resource data from the resource database;
receiving, at the one or more processors, dynamic resource data from the resource database, wherein the dynamic resource data includes active course data and number of seats available in each active course, wherein the active course includes one or more available seats, and wherein the dynamic resource data is generated and received in real-time, and wherein the receiving of the dynamic resource data is repeated periodically to obtain up to date information;
obtaining, at the one or more processors, user resource selections, wherein obtaining user resource selections includes:
obtaining one or more active school terms;
presenting, for display to a user, courses, including the active courses, associated with the one or more active school terms, wherein the active courses include an identifier informing the user that the course with the identifier is the active course; and
obtaining an add indication from the user for one or more courses, wherein the add indication corresponds to simulation of a course schedule prior to enrolment;
generating, using the one or more processors, a set of results based on the static resource data, the dynamic resource data and the user resource selections, the set of results including one or more weekly schedules;
providing user interface controls adapted to permit the user to visually move through the set of results by displaying a weekly view of one weekly schedule from the set of results;
obtaining a final selection of a selected weekly schedule from the set of results, wherein the final selection comprises one or more of the active courses only; and
submitting the final selection for registration and the enrolment.

10. The system of claim 9, wherein the operations further include:
providing a user interface element adapted to permit the user to graphically select time blocks to avoid scheduling courses in; and
re-sorting the results set based on selected time blocks to avoid.

11. The system of claim 9, wherein the operations further include:
obtaining one or more limiting selections, wherein the one or more limiting selections include full courses, honors courses, online courses, waitlisted courses, full sections, class capacity, number of seats available, campus preferences, and one or more of time or distance between two courses that are adjacent in a schedule; and
generating a new set of results based on the limiting selections.

12. The system of claim 9, wherein obtaining the user resource selections further includes receiving one or more section preferences.

13. The system of claim 9, wherein obtaining the user resource selections further includes receiving a sort preference, wherein the sort preference includes most days off, morning classes, mid-day classes, evening classes, time off campus, healthy schedule with a lunch break, weekly schedule with balanced workload distributed over a week, and a highest score sort preference.

14. The system of claim 9, wherein the user interface includes a combined user interface with a first section adapted to permit a user to search courses, a second section adapted to add courses and a third section adapted visually review the results in an integrated interface.

15. The system of claim 9, wherein receiving an indication from the user on one of the results causes displaying within the weekly view a limited view of a selected course corresponding to the result.

16. The system of claim 9, wherein the operations are performed entirely on a user device.

17. A nontransitory computer readable medium having stored thereon software instructions that, when executed by a processor, cause the processor to perform operations including:
connecting to a resource database;
receiving static resource data from the resource database;
receiving dynamic resource data from the resource database, wherein the dynamic resource data includes active course data and number of seats available in each active course, wherein the active course includes one or more available seats, and wherein the dynamic resource data is generated and received in real-time, and wherein the receiving of the dynamic resource data is repeated periodically to obtain up to data information;
obtaining user resource selections, wherein obtaining user resource selections includes:
obtaining one or more active school terms;
presenting, for display to a user, courses, including the active courses, associated with the one or more active school terms, wherein the active courses include an identifier informing the user that the course with the identifier is the active course; and
obtaining an add indication from the user for one or more courses;
generating a set of results based on the static resource data, the dynamic resource data and the user resource selections, the set of results including one or more weekly schedules; and
providing, for display to a user, user interface controls adapted to permit the user to visually move through the set of results by displaying a weekly view of one weekly schedule from the set of results, wherein the operations are performed entirely on a user device.

18. The nontransitory computer readable medium of claim 17, wherein the operations further include:
Providing, for display to the user, a user interface element adapted to permit the user to graphically select time blocks to avoid scheduling courses in; and
re-sorting the results set based on selected time blocks to avoid.

19. The nontransitory computer readable medium of claim 17, wherein the operations further include:
obtaining one or more limiting selections, wherein the one or more limiting selections include full courses, honors courses, online courses, waitlisted courses, full sections, class capacity, number of seats available, campus preferences, and one or more of time or distance between two courses that are adjacent in a schedule; and
generating a new set of results based on the limiting selections.

20. The nontransitory computer readable medium of claim 17, wherein receiving an indication from the user on one of the results causes displaying within the weekly view a limited view of a selected course corresponding to the result.
